(19) United States
(12) Patent Application Publication
(10) Pub. No.: US 2006/0254536 A1
(43) Pub. Date: Nov. 16, 2006

(54) Engine control module linked additive injection system

(76) Inventors: Paul F. Waters, Washington, DC (US); John B. Waters, Washington, DC (US); Robert H. Lauchner, El Paso, TX (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/372,459

(22) Filed: Mar. 9, 2006

Related U.S. Application Data
(60) Provisional application No. 60/660,086, filed on Mar. 9, 2005.

(51) Int. Cl. F02M 25/00

(52) U.S. Cl. 123/1 A

(57) ABSTRACT

The invention includes an additive injection system for automatically metering a liquid fuel additive into the fuel supply of a fuel burning device. The additive injection system may be adapted to maintain a constant additive concentration in the fuel over a series of random fuel depletion and refueling cycles. Further, the additive injection system may be in communication with an engine control module to precisely determine the amount of fuel that has been consumed.

### RELATED APPLICATIONS

This application claims the benefit of U.S. Provisional Patent Application Ser. No. 60/660,086, titled Engine Control Module Linked Additive Injection System, filed Mar. 9, 2005, the contents of which are hereby incorporated by reference.

### FIELD OF THE INVENTION

The invention generally relates to an additive injection system. More specifically, the invention relates to an additive injection system in communication with an engine control module.

### BACKGROUND OF THE INVENTION

Fuel treatment additives are used to modify fuels, for example, to improve efficiency, increase power, and/or achieve air quality benefits. Many additives must be present in a specific concentration to have the optimum desired effect. Traditionally, such additives have been mixed into the fuel manually by measuring out the recommended quantity of additive per volume of fuel taken on at the fuel pump and pouring it into a tank. This method of mixing an additive into the fuel is inconvenient, and often imprecise, due to human error or neglect. Further, in automatic systems, the quantity of fuel added to a fuel tank has traditionally been determined from a sending unit line to a vehicle's fuel gauge. However, this is not an optimum indicator, as worn or sticking contacts on the float swing arm of the sending unit often produce erratic and unreliable measures at various positions on the unit's resistor.

### SUMMARY OF THE INVENTION

Embodiments of the invention include a system for automatically metering a liquid fuel additive into the fuel supply of a fuel burning device such as an internal combustion (IC) engine. In some embodiments the system is adapted to maintain a constant additive concentration in the fuel over a series of random fuel depletion and refueling cycles. Embodiments of the system provide several advantages, including adding a precise amount of additive to achieve a desired additive concentration in the fuel. In some embodiments, the system determines the fuel consumed value from data obtained from an engine control module, rather than relying on unreliable data from a fuel tank sending unit. Such a system allows for maintaining a relatively stable concentration of additive in the fuel to improve the additive's performance. Further, such a system avoids requiring a user to directly calculate and measure the correct amount of additive and introduce it into the fuel system, thereby avoiding disadvantages such as user error.

### BRIEF DESCRIPTION OF THE DRAWINGS

FIG. 1 shows an environmental view of a motor vehicle provided with an additive injection system in accordance with an embodiment of the invention.

FIG. 2 is a schematic view of an engine control module in accordance with an embodiment of the invention.

FIG. 3 is a schematic view of an additive injection system in communication with an engine control module in accordance with an embodiment of the invention.

FIG. 4 is a schematic view of an additive injection system in communication with a vehicle monitoring and management system onboard subsystem in communication with an engine control module in accordance with an embodiment of the invention.

FIG. 5 shows a schematic view of an additive injection system in accordance with an embodiment of the invention.

FIG. 6 shows a front plan view of a fuel tank sending unit in accordance with an embodiment of the invention.

### DETAILED DESCRIPTION OF THE INVENTION

For the purpose of promoting an understanding of the principles of the present invention, reference will now be made to the embodiments illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein, are contemplated as would normally occur to one skilled in the art to which the invention relates.

Some embodiments of the invention include an additive injection system (hereafter, “AIS”) useful for delivering a fuel additive to an IC engine in communication with an engine control module (hereafter, “ECM”). As used herein, the term “fuel additive” means a substance that is added to fuel and/or employed to treat effluent derived from the combustion of fuel. For example, the fuel additive may comprise a polymer adapted to improve the combustion efficiency of a fuel-burning device.

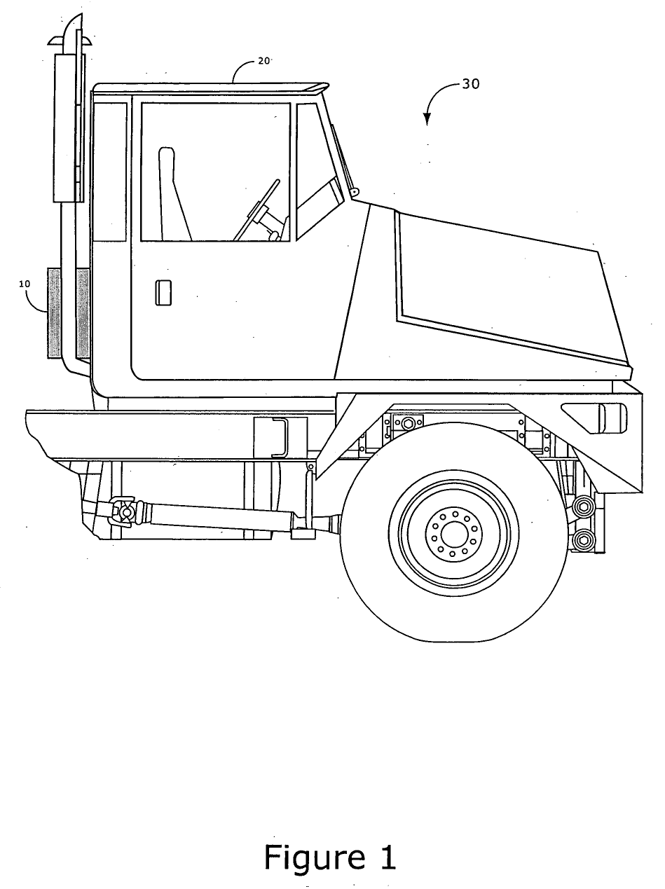

Further, the IC engine may be of any type, such as a gasoline engine, a diesel engine, a jet engine, a marine engine, a furnace, or a burner. In addition, the IC engine may be stationary (e.g., a diesel electric generator) or utilized in a vehicle. The term “vehicle” is used in its broadest sense, referring to any means in or by which something is carried or conveyed, and includes automobiles, trucks, airplanes, marine vehicles, off-road vehicles, recreational vehicles, construction equipment and the like. As an example, FIG. 1 shows an embodiment of an AIS 10 mounted on the rear of a cab 20 of a truck 30. Of course, an AIS may be mounted in any suitable location on or within a vehicle.

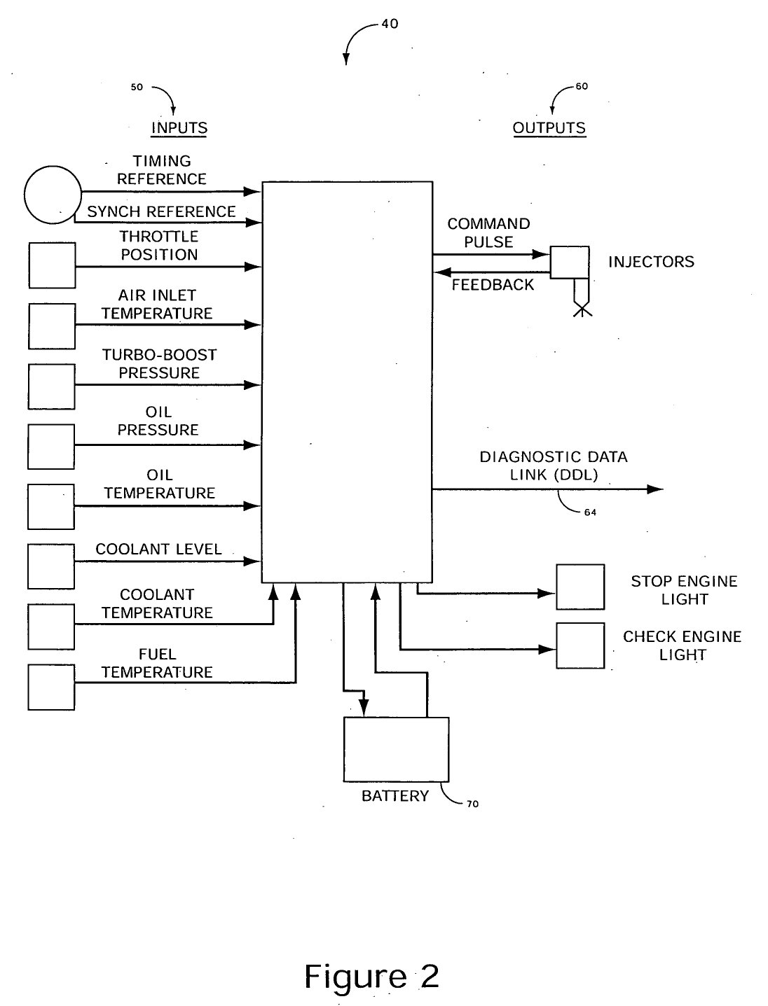

The ECM in communication with the AIS may be of any type. An embodiment of an ECM 40 is shown in FIG. 2. Generally, an ECM is a computerized electronic device designed to continuously monitor, analyze and govern engine performance based on inputs 50 from various sensors located in areas in and on the engine, such as throttle position, air inlet temperature, turbo-boost pressure, oil pressure, oil temperature, coolant level, coolant temperature, fuel temperature, and/or engine timing. A programmable read-only memory (PROM) that provides instructions for basic engine control functions may work in concert with an electronically erasable programmable read-only memory (EEPROM) that stores engine calibration values, allowing the ECM to record and adjust engine performance parameters, such as fuel consumption. As shown in FIG. 2, the ECM may also have several outputs 60, such as command pulses to the fuel injectors or outputs to the stop-engine and check-engine lights. Further, the ECM may have a diagnostic data link 64 to transfer data collected by the ECM to a querying device. As shown, the ECM may be powered by a battery 70.

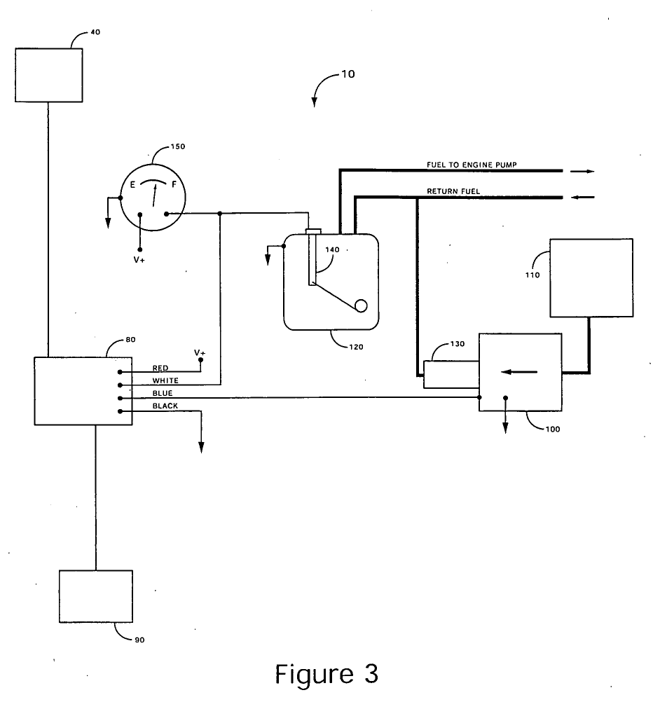

An embodiment of an AIS 10 in accordance with the invention is shown in FIG. 3. The AIS may include an additive control module 80 (hereafter, “ACM”) in communication with the ECM. The ACM may be useful for receiving information and providing commands useful for providing a correct amount of additive to a fuel tank. Such communication may occur either by wire or wirelessly. In some embodiments, an AIS receiver 90 may be provided as shown in FIG. 3. The AIS receiver may be any appropriate device that is capable of receiving and/or sending data either by wire or wirelessly. The ACM may also be in communication with an AIS pump 100. The AIS pump may be in fluid communication with an additive tank 110 and a fuel tank 120, and a valve 130 may be provided between the AIS pump and the fuel tank. Upon receiving a command, the AIS pump may pump additive from the additive tank to the fuel tank. The fuel tank may contain a sending unit 140 in communication with a vehicle fuel gauge and the ACM. The ACM may also be in communication with the sending unit.

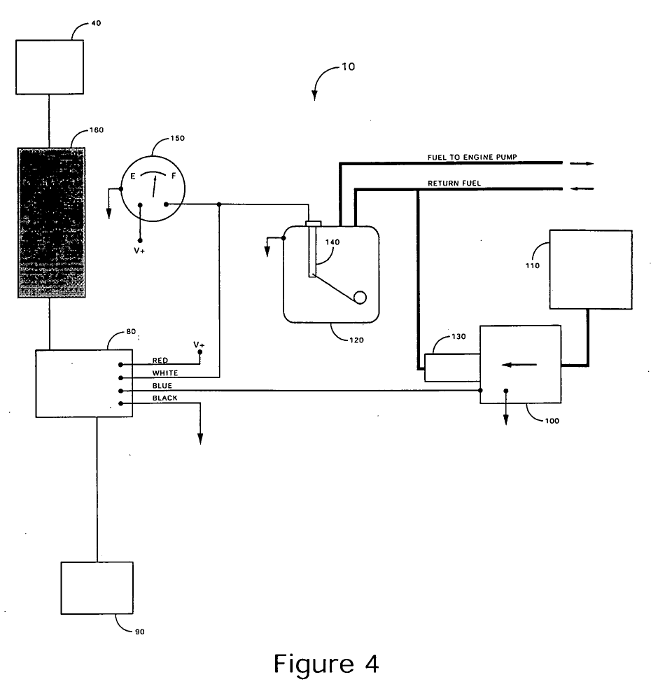

As shown in FIG. 4, the ACM may also be in communication with a vehicle monitoring and management system onboard subsystem (hereafter, “VMMSOS”) 160. The VMMSOS may be used for at least one of logging, tracking, reporting information or remotely triggering operations pertaining to vehicles (e.g., fleet vehicles). An example of a typical VMMSOS is PeopleNet's PerformX™. PerformX™ is a real-time evaluation tool in the PeopleNet wireless fleet management system that monitors a vehicle's performance by communicating with the engine's ECM. In that example, the ECM captures data relating to vehicle and driver performance and transmits it via the J 1708 serial-data protocol. The J 1708 serial-data protocol is a modification of the RS-485 serial data communication standard for heavy duty vehicle applications. Of course, any other suitable protocol could be utilized. Further, the ACM may communicate with the VMMSOS either by wire or wirelessly via the AIS receiver using any suitable data communications protocol.

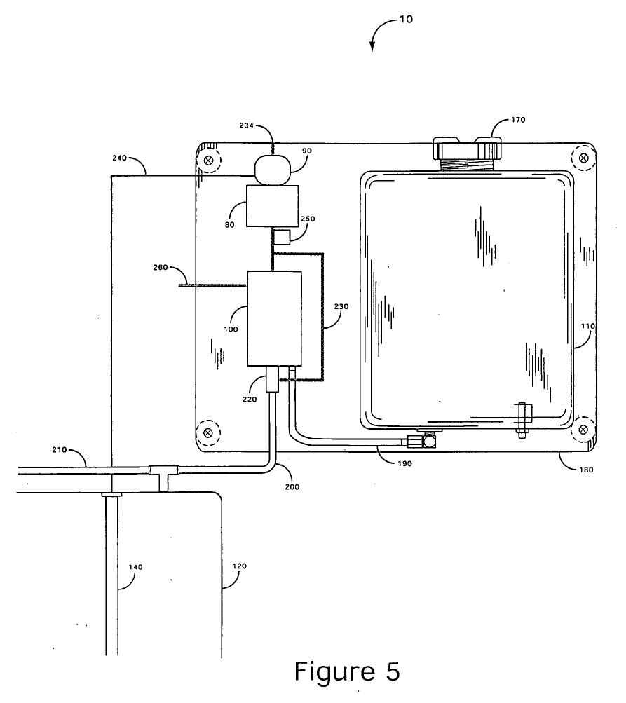

FIG. 5 shows an embodiment of an AIS in more detail. As shown, the AIS 10 may comprise an additive tank 110 to hold the additive to be injected into a fuel tank 120. The additive tank should be large enough to hold sufficient additive for several fuel depletion and refueling cycles, and should not contain a material that interacts with the additive. Further, the tank should be located in an area that is accessible to an operator for replenishing the additive supply. In some embodiments, a cap 170 is provided to close the additive tank. Such a cap may be vented to allow for pressure regulation. In some embodiments, various components of the AIS can be mounted to a mounting plate 180.

The additive tank may be in fluid communication with an AIS pump 100 through an additive line 190 to pump 100. The AIS pump may be any device capable of transferring additive from the additive tank to a fuel tank. In some embodiments, the AIS pump is a 12 Volt DC diaphragm pump. The AIS pump can transfer the additive to a fuel tank via an additive line 200 to the fuel tank. In some embodiments, the additive line to the fuel tank can feed into a return fuel line 210 feeding into the fuel tank. As shown in FIG. 5, a valve 220 may be provided between the AIS pump and the fuel tank. In some embodiments, the valve comprises a 12 Volt DC solenoid valve.

The AIS pump and valve may be controlled by an ACM 80. In some embodiments, the ACM is in physical communication (e.g., electrical communication) with the AIS pump and valve via a wire 230. The ACM may be any device suitable to perform its function, such as a microprocessor. In some embodiments, the ACM may include the processing, storage, and communications equipment to receive signals from the sending unit, query the ECM, receive data from the ECM, convert that data into an amount of additive to be added, instruct the pump to deliver the additive into the fuel system, and control any valves that may be present in the AIS. In some embodiments, the ACM may comprise a receiver 90 to receive and/or transmit data. Such a receiver may be powered by a 12 Volt DC power line. Further, the receiver may be adapted to receive communications either by wire or wirelessly. In some embodiments, a sending unit line 240 may be provided between the sending unit 140 and the receiver 90. As described further below, this line may be used to signal to the ACM that fuel has been added to a fuel tank. The receiver may also be able to communicate with an ECM or a VMMSOS.

The power requirements of the AIS may be met in any suitable way, such as connection to the power grid, single use batteries, rechargeable batteries, or using power from a vehicle's battery that is in turn charged from the IC engine. Power may be delivered to the AIS via input line 234. In the AIS shown in FIG. 5, a fuse 250 may be provided to shield the components from electrical surges. In addition, a ground connection 260 may be provided.

Such an AIS system can be installed in any suitable manner. For example, the components discussed above may be mounted to the mounting plate. The mounting plate may then be installed in any suitable location, such as on the rear of a cab as shown in FIG. 1. The AIS may then be connected to the vehicle's electrical system, the additive line may be directly or indirectly connected to the fuel tank, and the sending unit may be placed in communication with the ACM.

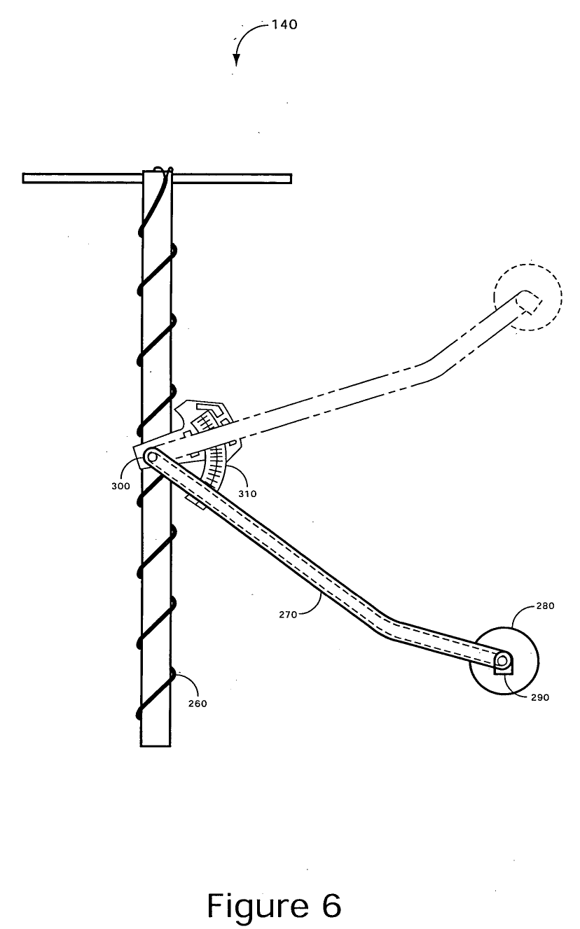

An embodiment of a typical sending unit is shown in more detail in FIG. 6. As shown, the sending unit 140 may comprise a swing arm 270 having a float 280 at its distal end 290. The float is adapted to rise and fall with changing fuel levels so as to pivot the swing arm about its proximal end 300. FIG. 6 shows the float in a relatively lower position in solid lines, indicating a low fuel level, and a relatively higher position in broken lines, indicating a high fuel level. The swing arm may be in contact with a resister 310. As the swing arm pivots, the resistance changes and a variable electrical signal dependent on the position of the fuel is generated and sent to a fuel gauge. This signal may also be used to alert the ACM that fuel has been added to the fuel tank.

In some embodiments, the AIS is in communication with the sending unit. In such embodiments, the AIS may determine when fuel has been added to the fuel tank. The AIS may use the signal that fuel has been added as a trigger mechanism to communicate with the ECM to determine the amount of fuel that has been added, as described further below, rather than determining the amount of fuel added from the sending unit itself.

On receiving the alert from the sending unit, the ACM may read the quantity of fuel consumed since the previous alert (hereafter, the “fuel consumed value”) from the ECM via data link 64. The ACM may then convert this reading to a numerical value, calculate the correct amount of additive to be injected into the vehicle's fuel system (hereafter, the “additive value”), and command the AIS pump to inject the additive value into the fuel tank.

In use, a user would fill up the fuel tank, thereby activating the sending unit. In the embodiment shown in FIG. 3, on receiving the alert from the sending unit, the ACM reads the fuel consumed value from the ECM via a data link (e.g., a SAE J1587/J1708 data link) to the engine's diagnostic port. The ACM then converts this reading to a numerical value, calculates the additive value, and commands the AIS pump to inject the additive value into the fuel tank. In some embodiments, the ACM reads the fuel consumed value from the ECM wirelessly via the AIS receiver.

In the embodiment shown in FIG. 4, on receiving the alert from the sending unit, the ACM may signal the VMMSOS to read the fuel consumed value from the ECM. On reading the fuel consumed value from the ECM, the VMMSOS may relay this value to the ACM where the command for the AIS pump to inject the additive value is processed. The ACM in turn may relay the command to the AIS pump to inject the additive value into the fuel tank. In other embodiments, on receiving the alert from the sending unit, the ACM may signal the VMMSOS to read the fuel consumed value from the ECM, whereupon the VMMSOS may convert the fuel consumed value to a numerical value, and process a command for the AIS pump to inject the additive value. The ACM may then relay the command from the VMMSOS to the AIS pump to inject the additive value into the fuel tank. Further, in some embodiments, the ACM communicates with the VMMSOS wirelessly via the AIS receiver.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations, which fall within the spirit and broad scope of the invention.

What is claimed is:

1. An additive injection system comprising an additive control module to automatically add an appropriate amount of an additive to a fuel system of an internal combustion engine, the additive control module in communication with an engine control module to determine a fuel consumed value.

2. The additive injection system of claim 1, wherein the additive control module is prompted to read the fuel consumed value from the engine control module upon receiving a signal from a sending unit.

3. The additive injection system of claim 1, the additive injection system further comprising a pump to inject the additive into the fuel system, wherein the additive control module is adapted to convert the fuel consumed value to a numerical value, calculate an additive value, and command the pump to inject the additive into the fuel system.

4. The additive injection system of claim 1, wherein the additive injection system includes a receiver adapted to enable the additive control module to communicate either by wire or wirelessly with the engine control module.

5. The additive injection system of claim 1, wherein the additive control module is in communication with a vehicle monitoring and management system onboard subsystem which reads the fuel consumed value from the engine control module and relays the fuel consumed value to the additive control module.

6. The additive injection system of claim 1, wherein the additive control module is in communication with a vehicle monitoring and management system onboard subsystem which reads the fuel consumed value from the engine control module, processes an additive value, and relays the additive value to the additive control module.

7. The additive injection system of claim 1, wherein the additive injection system includes a receiver adapted to enable the additive control module to communicate either by wire or wirelessly with a vehicle monitoring and management system onboard subsystem.

8. The additive injection system of claim 1, wherein the additive control module is adapted to query the engine control module upon receiving a signal from a sending unit.

9. The additive injection system of claim 1, wherein the additive injection system further includes an additive tank.

10. The additive injection system of claim 1, wherein the additive injection system further includes a pump in communication with the additive control module and a valve located between the pump and a fuel tank.

11. A method of injecting an additive into a fuel system comprising providing an additive injection system having an additive control module, signaling the additive control module that fuel has been added, and reading an engine control module to determine a fuel consumed value.

12. The method of claim 11, wherein the additive control module is prompted to read the fuel consumed value from the engine control module upon receiving a signal from a sending unit.

13. The method of claim 11, the additive injection system further comprising a pump to inject the additive into the fuel system, wherein the additive control module is adapted to convert the fuel consumed value to a numerical value, calculate an additive value, and command the pump to inject the additive into a fuel system.

14. The method of claim 11, wherein the additive injection system includes a receiver adapted to enable the additive control module to communicate either by wire or wirelessly with the engine control module.

15. The method of claim 11, wherein the additive control module is in communication with a vehicle monitoring and management system onboard subsystem which reads the fuel consumed value from the engine control module and relays the fuel consumed value to the additive control module.

16. The method of claim 11, wherein the additive control module is in communication with a vehicle monitoring and management system onboard subsystem which reads the fuel consumed value from the engine control module, processes an additive value, and relays the additive value to the additive control module.

17. The method of claim 11, wherein the additive injection system includes a receiver adapted to enable the additive control module to communicate either by wire or wirelessly with a vehicle monitoring and management system onboard subsystem.

18. The method of claim 11, wherein a signal from a sending unit prompts the additive control module to query the engine control module.

19. The method of claim 11, wherein the additive injection system further includes an additive tank.

20. The method of claim 11, wherein the additive injection system further includes a pump in communication with the additive control module and a valve located between the pump and a fuel tank.
